(19) United States
(12) Patent Application Publication
(10) Pub. No.: US 2007/0137901 A1
(43) Pub. Date: Jun. 21, 2007

(54) Micro-keyboard simulator

(75) Inventor: Stephen Chen, Changhua (TW)

Correspondence Address: BRUCE H. TROXELL, SUITE 1404, 5205 LEESBURG PIKE, FALLS CHURCH, VA, 22041, US

(73) Assignee: E-Lead Electronic Co., Ltd.

(21) Appl. No.: 11/304,803

(22) Filed: Dec. 16, 2005

(51) Int. Cl. G08C 21/00

(52) U.S. Cl. 178/18.01; 345/173

(57) ABSTRACT

The present invention relates to a micro-keyboard simulator, and more particularly to a micro-keyboard simulator whose operating surface for inputting commands includes two pressure inductive stages. It comprises a first pressure inductive device and a second pressure inductive device, wherein the first pressure inductive device is capable of detecting finger touch and analyzing coordinates and connects to a mainframe so as to display at least one symbol table on the monitor and the symbols of the symbol table are mutually corresponding to the surface coordinates of the micro-keyboard simulator; and the second pressure inductive device is capable of detecting the press-down action of the finger. Through the abovementioned combination, it greatly reduces the volume of the keyboard and is able to know the pressed character in advance so as to reduce the frequency of the user glancing at the keyboard.

### BACKGROUND OF THE INVENTION

1. Field of the Invention

The present invention relates to a micro-keyboard simulator, and more particularly to a micro-keyboard simulator whose operating surface for inputting commands includes two pressure inductive stages so as to achieve the micro-miniaturization of keyboard and improve input accuracy and convenience.

2. Description of the Related Art

The prosper development of information and telecommunication technology, in addition to the micro-miniaturization of semi-conductors and the high degree of system integration, allows many products that used to be large-sized and limited to indoor use, such as telephone, computer, etc., to constantly move toward the direction of becoming lighter, thinner, shorter, and smaller.

Although their volumes have reduced, it is limited by the monitor and inputting apparatus, especially the inputting apparatus, wherein the inputting apparatus usually is a press-button keyboard whose press-button number is either in teens, like those on a telephone, or more than a hundred arranged in order and in groups, like those on a computer, and it is required to fit the finger size so that the press-button cannot be too small. Therefore, the surface area of a keyboard is quite large, which is one of the reasons why the volumes of hand-held products cannot be further reduced.

Moreover, for an amateur typist, the biggest complaint is that he or she needs to lower his or her head to glance at the keyboard to look for or confirm the inputted character keys, and then to raise his or her head again to look at the monitor to examine the correctness of the characters just inputted, especially when switching among more than two different languages. For example, when inputting Japanese, Chinese, and English at the same time, the same key is used to inputting English, Japanese or Chinese under different conditions, so the user needs to frequently lower his or her head to concentrate on the keys, and then after a series of characters raises his or her head to find out that mistakes were made. In addition, if the keys are too small or the lighting condition is too dark, it may not be easy to distinguish the keys on the keyboard and influences the speed and convenience of character inputting.

Besides, the inputting methods are limited by the symbols printed on the keyboard, e.g., the phonetic symbols, Chang-Chieh codes, Da-Yi codes, and English letters commonly printed on a Taiwanese keyboard, so it is often unable to accomplish the inputting tasks if we want to input Japanese, Korean, or other non-English or non-Chinese characters since there is no such symbol printed on the keyboard.

### SUMMARY OF THE INVENTION

Therefore, in view of the input inconvenience and bulk volume of the prior art, the inventor proposes a micro-keyboard simulator in accordance with the present invention. The main objective of the present invention is to provide a micro-keyboard simulator whose operating surface for inputting commands includes two pressure inductive stages and comprises a first pressure inductive device and a second pressure inductive device, wherein the first pressure inductive device is capable of detecting finger touch and analyzing coordinates and operates in coordination with at least one symbol table in which the symbols of the symbol table are mutually corresponding to the surface coordinates of the micro-keyboard simulator; and the second pressure inductive device is capable of detecting the press-down action of the finger to execute the command inputting tasks. Through the abovementioned combination, it is able to achieve the micro-miniaturization of keyboard and improve input accuracy and convenience.

The first pressure inductive device according to the preferred embodiment of the present invention is a resistance-type pressure inductive panel.

The first pressure inductive device according to the preferred embodiment of the present invention is a capacitance-type pressure inductive panel.

The second pressure inductive device is installed underneath the first pressure inductive device.

The second pressure inductive device according to the preferred embodiment of the present invention is a resistance-type pressure inductive panel.

The second pressure inductive device according to the preferred embodiment of the present invention is a capacitance-type pressure inductive panel.

The first pressure inductive device according to the preferred embodiment of the present invention is activated when the finger touches it and the symbol on the monitor disappears when the finger moves away from the first pressure inductive device.

The second pressure inductive device is a press switch installed underneath the first pressure inductive device.

When the finger touches and moves the first pressure inductive device according to the preferred embodiment of the present invention, the symbol of the symbol table on the monitor generates different prompt signals corresponding to the coordinates of finger locations, e.g., the change of color or the signal of alter-shaped symbol, for the user to verify, so that the user is able to verify the selected symbol in advance before pressing the key.

The symbol table displayed on the monitor according to the preferred embodiment of the present invention is dependent upon different input requirements so that the software provides different corresponding symbol tables.

The symbol table displayed on the monitor according to the preferred embodiment of the present invention is controlled by two independent micro-keyboard simulators.

The surface of the first pressure inductive device according to the preferred embodiment of the present invention includes tactile embossing dots so that the user is able to quickly determine location.

The first and the second pressure inductive devices according to the preferred embodiment of the present invention are composed of a single pressure inductive device so as to distinguish whether the first-stage inductive signal or the second-stage inductive signal according to the magnitude of finger pressure received by the single pressure inductive device.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a three-dimensional structural view of a preferred embodiment of the present invention;

FIG. 2 is the block view of the preferred embodiment of the present invention.

FIG. 3 is the operating example (1) according to a preferred embodiment of the present invention;

FIG. 4 is the flow chart of the operating procedures according to the preferred embodiment of the present invention;

FIG. 5 is the symbol table (1) of the preferred embodiment of the present invention;

FIG. 6 is the symbol table (2) of the preferred embodiment of the present invention;

FIG. 7 is the operating example (2) according to a preferred embodiment of the present invention;

FIG. 8 is a one-dimensional coordinate view of the first pressure inductive device according to the preferred embodiment of the present invention;

FIG. 9 is a two-dimensional coordinate view of the first pressure inductive device according to the preferred embodiment of the present invention;

FIG. 10 is a structural view of the embossing dots on the surface of the first pressure inductive device according to the preferred embodiment of the present invention;

FIG. 11 is a structural view of another preferred embodiment (1) of the present invention;

FIG. 12 is a structural view of another preferred embodiment (2) of the present invention; and

FIG. 13 is a pressure curve chart of another preferred embodiment (2) of the present invention.

### DESCRIPTION OF THE PREFERRED EMBODIMENTS

Hereinafter, the components and preferred embodiments according to the present invention will be described in detail with reference to the accompanying drawings.

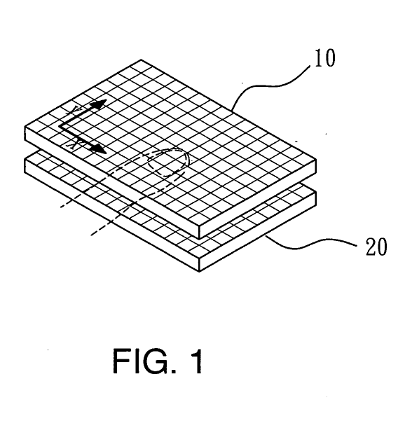

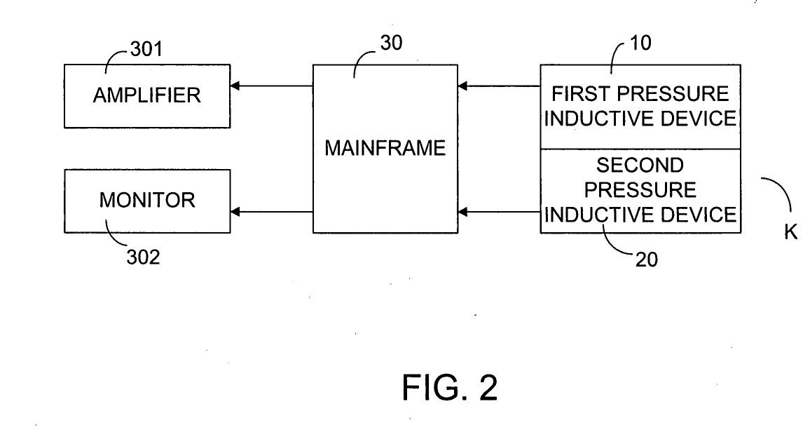

First, referring to FIGS. 1, 2 and 3, the present invention is a micro-keyboard simulator comprising a first pressure inductive device 10 and a second pressure inductive device 20, wherein:

Said first pressure inductive device 10 is capable of detecting finger touch and analyzing coordinates and connects to a mainframe 30 which though the monitor 302 displays at least one symbol table 4, and a symbol 41 of said symbol table 4 is mutually corresponding to the surface coordinates of the micro-keyboard simulator. Said first pressure inductive device 10 is a resistance-type pressure inductive panel or a capacitance-type pressure inductive panel.

Said second pressure inductive device 20 is installed underneath said first pressure inductive device 10 and is capable of detecting the press-down action of the finger to execute the command inputting tasks. Said second pressure inductive device 20 is a resistance-type pressure inductive panel or a capacitance-type pressure inductive panel

Furthermore, said mainframe 30 according to a preferred embodiment of the present invention, whose said monitor 302 includes at least one said symbol table 4 that is corresponding to said first pressure inductive device 10, is activated when detecting finger touch through said first pressure inductive device 10 and displays said symbol 41 (or control command) of said symbol table 4 corresponding to the finger touched coordinates on said monitor 302, or, moreover, generates the pronunciation of said symbol 41 (or control command) of said symbol table 4 corresponding to the finger touched coordinates through a amplifier 301 so as to allow the manipulation of people with bad eyesight or the blind. When the finger moves away from said first pressure inductive device 10, said symbol 41 on said monitor 302 disappears.

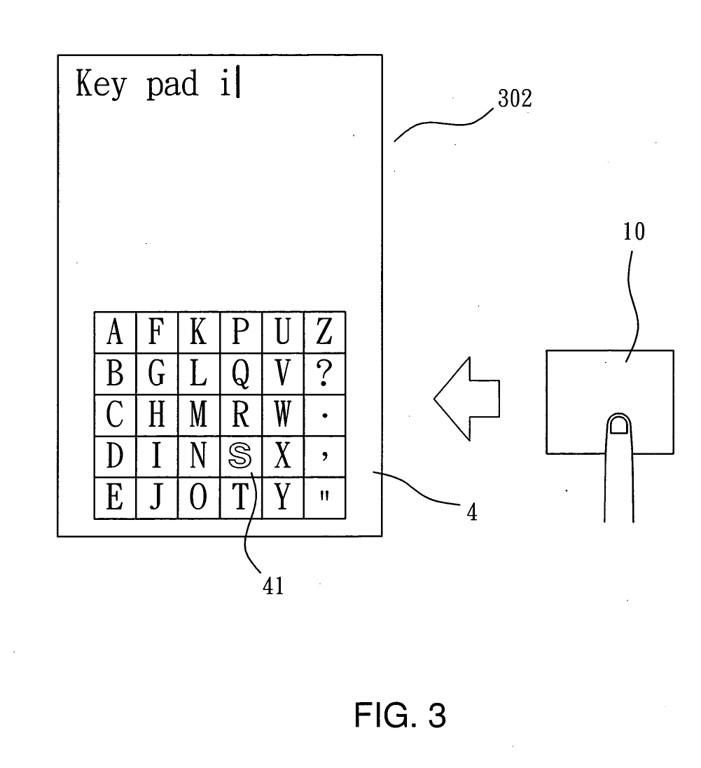

The present invention relates to said micro-keyboard simulator, wherein, when the finger touches and moves said first pressure inductive device 10, the symbol of said symbol table 4 on the monitor 302 generates different prompt signals corresponding to the coordinates of finger locations, e.g., the change of color or the signal of alter-shaped symbol (for example, as shown in FIG. 3, the “S” symbol becomes a different prompt variation), for the user to verify, so that the user is able to verify the selected symbol in advance before pressing the key.

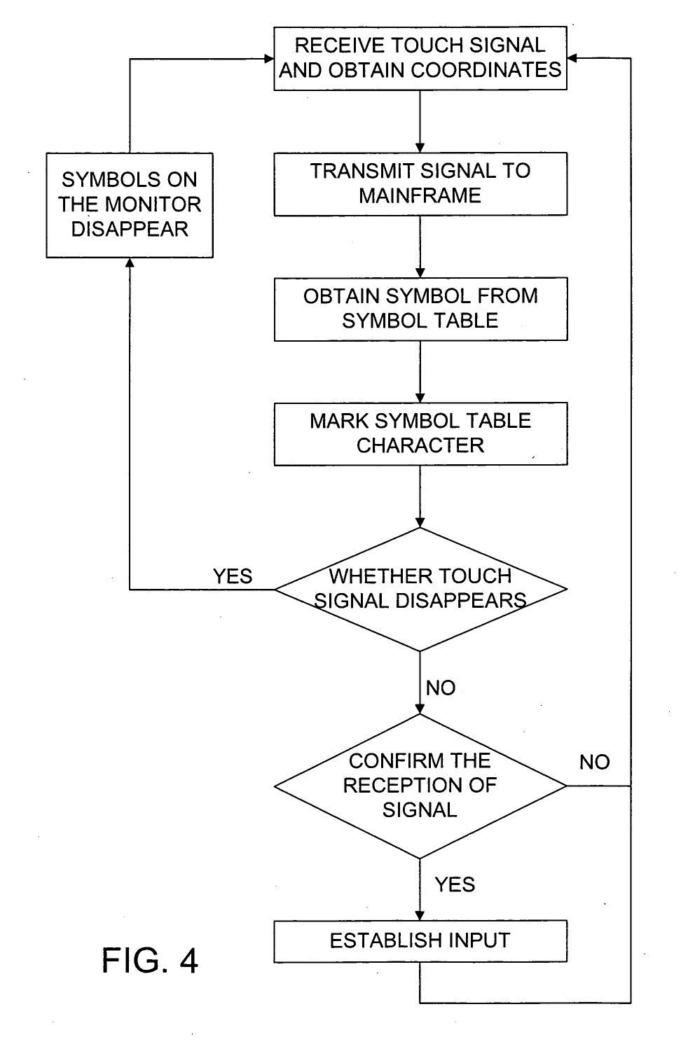

By the way of composing the abovementioned components, the operating procedures according to the present invention are listed as follows, as shown in FIG. 4:

Step 1

Receive touch signal and obtain coordinates: said first pressure inductive device 10 receives the finger touch to generate a signal and obtains the coordinates of the finger-touched location.
   Step 2
Transmit signal to mainframe: the finger touch signal received by said first pressure inductive device 10 and the coordinates of touched location are transmitted to said mainframe 30.
   Step 3
Obtain symbol from symbol table: obtain said symbol 41 corresponding to the coordinates from said symbol table 4 based upon said symbol table 4 set by said mainframe 30.
   Step 4
Mark symbol table character: said symbol 41 corresponding to the finger touched location is marked in different color in said symbol table 4 on said monitor 30.
   Step 5
Whether touch signal disappears: whether the finger touch signal received by said first pressure inductive device 10 disappears, if yes then go to step 8, if not step 6.
   Step 6
Confirm the reception of signal: said second pressure inductive device 20 detects the force whether the finger firmly presses down, if yes go to step 7 if not return to step 1.
   Step 7

Establish input: if the character of said symbol table 4 is shown at the input location of the operating system to accomplish the input of the character, return to step 1.

Step 8

Symbol on monitor disappears: after a period of set delay, when said symbol 41 on said monitor 30 disappears, return to step 1.

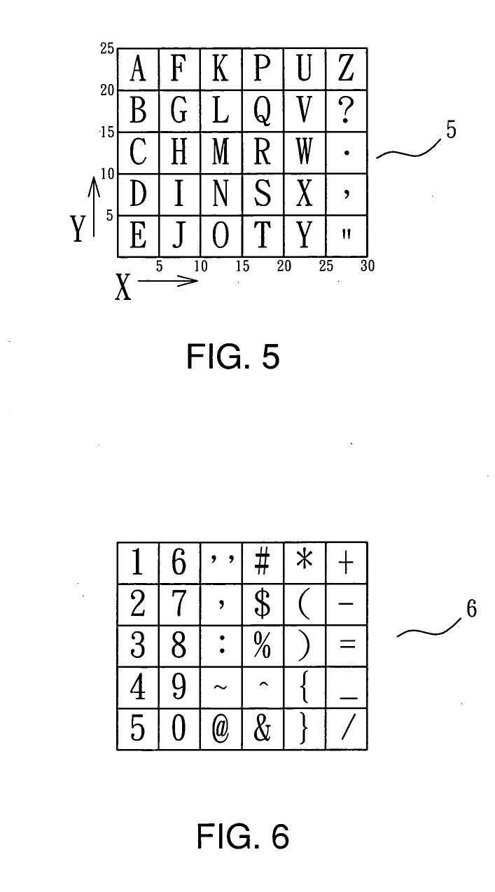

Please refer to FIGS. 5 and 6, the representation views of two different symbol tables 5, 6 according to the preferred embodiments of the present invention, wherein, when the finger presses on the different locations of said micro-keyboard simulator means inputting different characters and said symbol tables 5, 6 shown on said monitor 30 are also dependent upon different inputting requirements so that the software provides different corresponding symbol tables for the user to use.

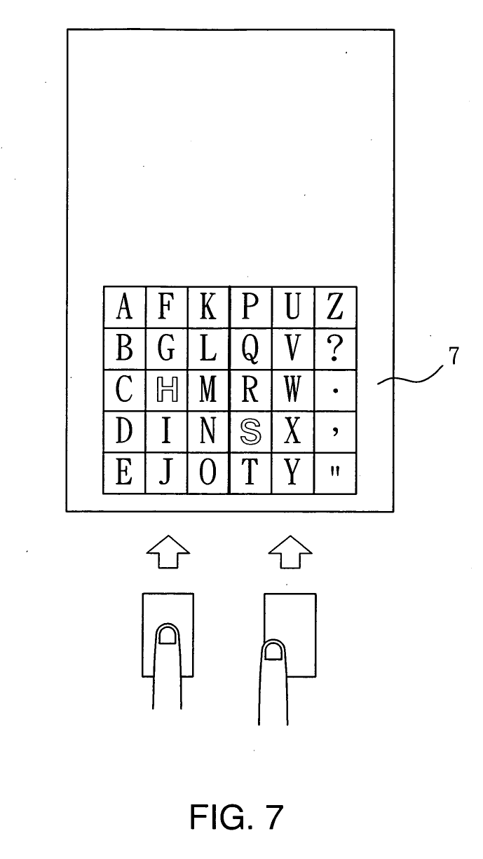

As shown in FIG. 7, in order to allow the input keyboard not limited to a single section, the symbol table is partially divided so as to input separately through more than one independent micro-keyboard simulator.

As shown in FIG. 10, in order for the user to quickly differentiate the current finger location, there are tactile embossing dots 101 on the surface of said first pressure inductive device 10 so that the user is able to quickly differentiate location through tactile sense without further lowing his or her head.

In order to reduce volume, as shown in FIG. 12, 13, said first pressure inductive device and said second pressure inductive device in according to the present invention are composed of a single pressure inductive device 13, wherein said single pressure inductive device 13 is capable of analyzing the magnitude of pressure so as to distinguish among no-response, first stage pressure inductive section, and second stage pressure inductive section according to the magnitude of received finger pressure. When the magnitude of touch pressure is less than F1, it is considered as no response; when the magnitude of touch pressure is larger than F1 but less than F2, it is considered as the signal of said first stage pressure inductive section, i.e., detecting the coordinates of inductive finger touch; when the magnitude of touch pressure is larger than F2, it is considered as the signal of said second stage pressure inductive section, i.e., confirming the finger press action to execute the command input.

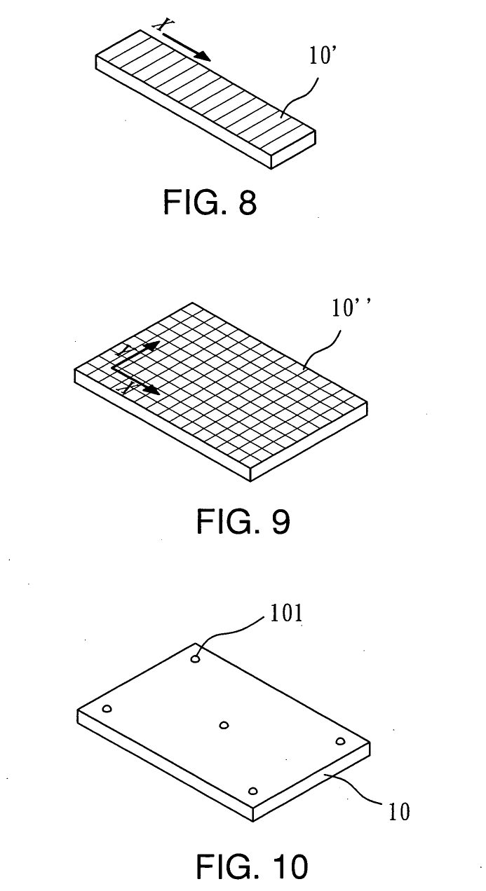

As shown in FIG. 8, 9, said first pressure inductive devices 10′, 10″ in according to the present invention are capable of analyzing coordinates, i.e., there are different corresponding one-dimensional coordinate values corresponding to the different locations on the surface of said micro-keyboard simulator.

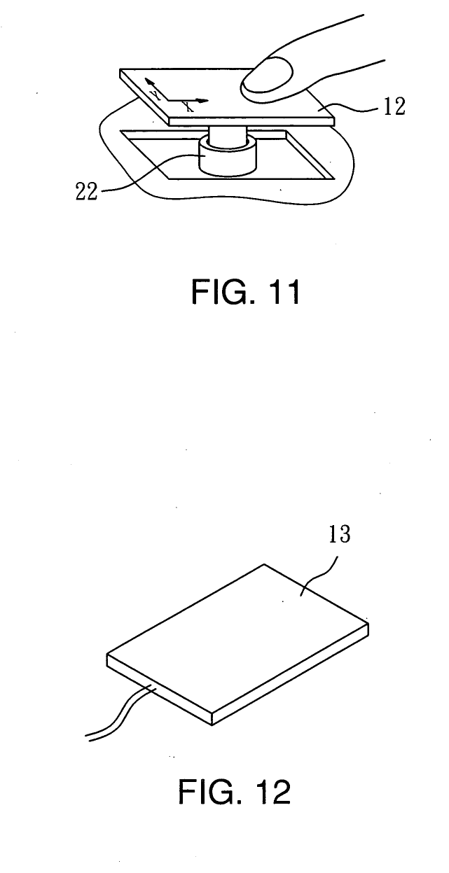

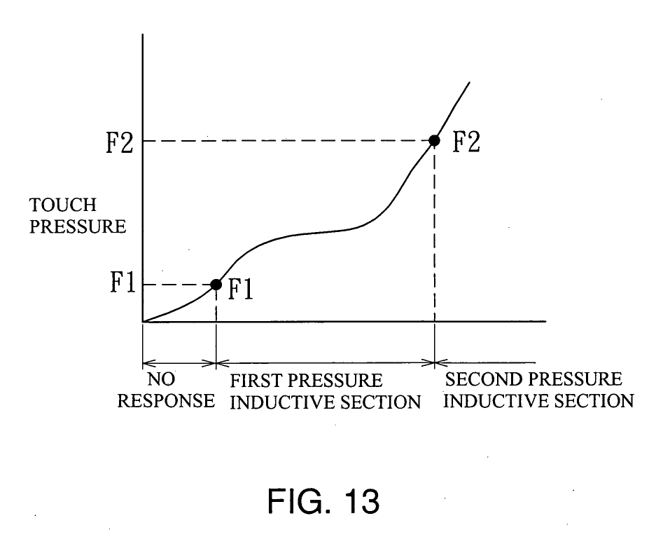

Moreover, as shown in FIG. 11, it is another preferred embodiment according to the present invention, wherein said second pressure inductive device 22 is a pressure switch installed underneath said first pressure inductive device 12.

As conclusion, the present invent is able to facilitate the input of different symbols through a single key and further improve the input convenience and accuracy.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

I claim:

1. A micro-keyboard simulator, which including two pressure inductive stages, comprising a first pressure inductive device, and a second pressure inductive device, wherein:
said first pressure inductive device is capable of detecting finger touch and analyzing coordinates and operates in coordination with at least one symbol table in which the symbols of said symbol table are mutually corresponding to the surface coordinates of said micro-keyboard simulator; and
said second pressure inductive device is capable of detecting the press-down action of the finger to execute the command inputting tasks.

2. The micro-keyboard simulator as set forth in claim 1, wherein said first pressure inductive device is a resistance-type pressure inductive panel.

3. The micro-keyboard simulator as set forth in claim 1, wherein said first pressure inductive device is a capacitance-type pressure inductive panel.

4. The micro-keyboard simulator as set forth in claim 1, wherein said second pressure inductive device is installed underneath said first pressure inductive device.

5. The micro-keyboard simulator as set forth in claim 1, wherein said second pressure inductive panel is a resistance-type pressure inductive panel.

6. The micro-keyboard simulator as set forth in claim 1, wherein said second pressure inductive device is a capacitance-type pressure inductive panel.

7. The micro-keyboard simulator as set forth in claim 1, wherein said second pressure inductive device is a press switch.

8. The micro-keyboard simulator as set forth in claim 1, wherein the surface of said first pressure inductive device has tactile embossing dots for the user to quickly differentiate location.

9. The micro-keyboard simulator as set forth in claim 1, wherein said first pressure inductive device and said second pressure inductive device are composed of a single pressure inductive device so as to distinguish whether the first-stage inductive signal or the second-stage inductive signal according to the magnitude of finger pressure received by said single pressure inductive device.

10. The micro-keyboard simulator as set forth in claim 1, wherein said symbol table are displayed on the monitor.

11. The micro-keyboard simulator as set forth in claim 1, wherein said symbol table displayed on said monitor is dependent upon different input requirements so that the software provides different corresponding symbol tables.

12. The micro-keyboard simulator as set forth in claim 1, wherein said symbol table displayed on said monitor is controlled by more than on independent said micro-keyboard simulator.

13. The micro-keyboard simulator as set forth in claim 1, wherein said first pressure inductive device is activated when touched by the finger and said symbol on said monitor disappears when the finger moves away from said first pressure inductive device.

14. The micro-keyboard simulator as set forth in claim 1, wherein when the finger touches and moves said first pressure inductive device, the symbol of said symbol table on said monitor generates different prompt signals corresponding to the coordinates of finger locations, e.g., the change of color or the signal of alter-shaped symbol, for the user to verify, so that the user is able to verify the selected symbol in advance before pressing the key.

15. The micro-keyboard simulator as set forth in claim 1, wherein said coordinator analyzing capability is that there are different corresponding one-dimensional coordinate values corresponding to the different locations on the surface of said micro-keyboard simulator.

16. The micro-keyboard simulator as set forth in claim 1, said coordinator analyzing capability is that there are different corresponding two-dimensional coordinate values corresponding to the different locations on the surface of said micro-keyboard simulator.
